(19) United States
(12) Patent Application Publication
(10) Pub. No.: US 2023/0116012 A1
(43) Pub. Date: Apr. 13, 2023

(54) ROTOR, MOTOR, COMPRESSOR, AIR CONDITIONER, AND MANUFACTURING METHOD OF ROTOR

(71) Applicant: Mitsubishi Electric Corporation, Tokyo (JP)

(72) Inventor: Masahiro NIGO, Tokyo (JP)

(21) Appl. No.: 17/911,573

(22) PCT Filed: Apr. 20, 2020
(86) PCT No.: PCT/JP2020/017035

§ 371 Date: Sep. 14, 2022

(51) Int. Cl. H02K 1/276; H02K 21/16; H02K 15/03; F25B 31/02

(52) U.S. Cl. CPC H02K 1/2766; H02K 21/16; H02K 15/03; F25B 31/026

(57) ABSTRACT

A rotor includes a rotor core having a magnet insertion hole and having an annular shape about an axis, and a permanent magnet of a flat plate shape disposed in the magnet insertion hole and having a thickness and a width in a plane perpendicular to the axis. The thickness of the permanent magnet defines a thickness direction, and the width of the permanent magnet defines a widthwise direction. The magnet insertion hole has a portion inclined relative to the widthwise direction so that an opening dimension T1 in the thickness direction at an end of the magnet insertion hole in the widthwise direction is smaller than an opening dimension T2 in the thickness direction at a position distanced from the end by the width of the permanent magnet.

### CROSS REFERENCE TO RELATED APPLICATION

This application is a U.S. national stage application of International Patent Application No. PCT/JP2020/017035 filed on Apr. 20, 2020, the disclosure of which is incorporated herein by reference.

### TECHNICAL FIELD

The present disclosure relates to a rotor, a motor, a compressor, an air conditioner, and a manufacturing method of the rotor. BACKGROUND

In a permanent magnet embedded rotor, a permanent magnet is disposed in a magnet insertion hole formed in a rotor core. A protrusion for restricting the position of the permanent magnet is provided at the magnet insertion hole (see, for example, Patent Reference 1).

### PATENT REFERENCE

Patent Reference 1: Japanese Patent Application Publication No. 2009-247131 (see FIG. 1)

Meanwhile, when a large current flows through a stator coil, such as when a large load is applied to the motor, the permanent magnet may be demagnetized by magnetic flux from a stator. If the protrusion is provided in the magnet insertion hole, the magnetic flux from the stator tends to flow into the permanent magnet through the protrusion, and the demagnetization of the permanent magnet is likely to occur.

### SUMMARY

The present disclosure is intended to solve the above-described problem, and an object of the present disclosure is to suppress the demagnetization of a permanent magnet.

A rotor of the present disclosure includes a rotor core having a magnet insertion hole and having an annular shape about an axis, and two permanent magnets disposed in the magnet insertion hole, the two permanent magnets being disposed on both sides of a center of the magnet insertion hole in a circumferential direction about the axis, each of the two permanent magnets having a flat plate shape and having a thickness and a width in a plane perpendicular to the axis. The thickness defines a thickness direction, and the width defines a widthwise direction. The magnet insertion hole has a portion inclined relative to the widthwise direction so that an opening dimension T1 in the thickness direction at an end of the magnet insertion hole in the widthwise direction is smaller than an opening dimension T2 in the thickness direction at the center of the magnet insertion hole in the circumferential direction. A thickness H1 of a portion of each of the two permanent magnets disposed at the end of the magnet insertion hole is narrower than a thickness H2 of a portion of each of the two permanent magnets disposed at the center of the magnet insertion hole.

According to the present disclosure, the permanent magnet is held at the portion of the magnet insertion hole having the opening dimension T1, and thus it is not necessary to form a protrusion for positioning the permanent magnet in the magnet insertion hole. Thus, it is possible to suppress the demagnetization of the permanent magnet due to the flow of magnetic flux from the stator through the protrusion.

### BRIEF DESCRIPTION OF THE DRAWINGS

FIG. 1 is a sectional view illustrating a motor of a first embodiment.

FIG. 2 is a sectional view illustrating a rotor of the first embodiment.

FIG. 3 is an enlarged sectional view illustrating a part of the rotor of the first embodiment.

FIG. 4 is an enlarged sectional view illustrating a part of a rotor core of the first embodiment.

FIG. 5 is a schematic diagram for explaining the contact state between the rotor core and a permanent magnet in a magnet insertion hole of the first embodiment.

FIG. 6 is an enlarged sectional view illustrating the magnet insertion hole of the first embodiment.

FIG. 7 is a diagram illustrating a manufacturing process of the rotor in the first embodiment.

FIG. 8 is a diagram illustrating an insertion step of the permanent magnet in the first embodiment.

FIGS. 9(A) to 9(C) are schematic diagrams for explaining the insertion step of the permanent magnet in the first embodiment.

FIG. 10 is an enlarged sectional view illustrating a part of a rotor of Comparative Example 1.

FIG. 11 is a diagram illustrating comparison of the amount of magnetic flux interlinked with a stator coil between the first embodiment and Comparative Example 1.

FIG. 12 is a diagram illustrating comparison of 3% demagnetization current between the first embodiment and Comparative Example 1.

FIG. 13 is an enlarged diagram illustrating a part of a rotor of a modification of the first embodiment.

FIG. 14 is a sectional view illustrating a motor of a second embodiment.

FIG. 15 is an enlarged sectional view illustrating a part of a rotor of the second embodiment.

FIG. 16 is an enlarged sectional view illustrating a part of a rotor core of the second embodiment.

FIG. 17 is an enlarged sectional view illustrating a magnet insertion hole of the second embodiment.

FIGS. 18(A) to 18(C) are schematic diagrams for explaining an insertion step of permanent magnets in the second embodiment.

FIG. 19 is an enlarged sectional view illustrating a part of a rotor of Comparative Example 2.

FIG. 20 is an enlarged diagram illustrating a part of a rotor of a modification of the second embodiment.

FIG. 21 is an enlarged sectional view illustrating a part of a rotor of a third embodiment.

FIG. 22 is an enlarged sectional view illustrating a part of a rotor core of the third embodiment.

FIG. 23 is an enlarged sectional view illustrating a part of a rotor of a modification of the third embodiment.

FIG. 24 is a sectional view illustrating a compressor to which the motor of each embodiment is applicable.

FIG. 25 is a diagram illustrating an air conditioner that includes the compressor illustrated in FIG. 24.

### DETAILED DESCRIPTION

### First Embodiment

### (Configuration of Motor)

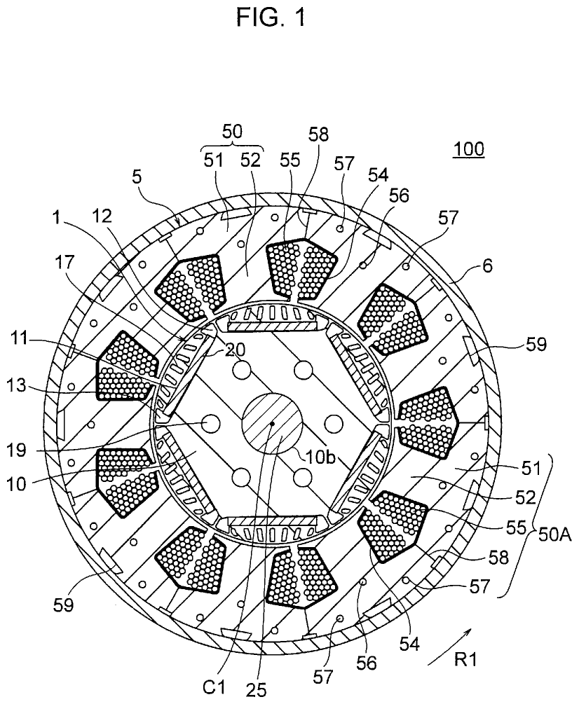

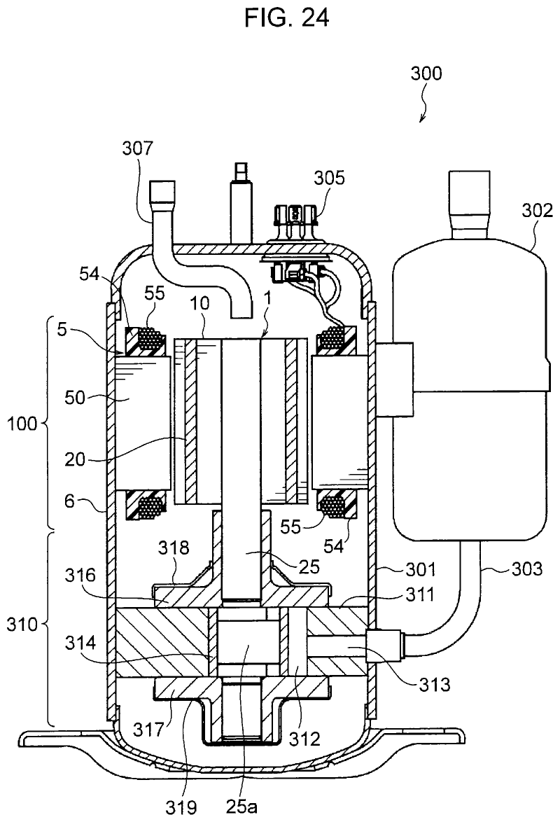

First, a motor 100 of a first embodiment will be described. FIG. 1 is a cross-sectional view illustrating the motor 100 of the first embodiment. The motor 100 is a permanent magnet embedded motor that has permanent magnets 20 embedded in a rotor 1. The motor 100 is used in, for example, a compressor 300 (FIG. 24).

The motor 100 includes the rotor 1 that is rotatable and a stator 5 that surrounds the rotor 1. An air gap of, for example, 0.3 to 1.0 mm, is formed between the stator 5 and the rotor 1. The stator 5 is fixed to a cylindrical shell 6, which is a part of the compressor 300.

Hereinafter, the direction of an axis C1, which is a rotating axis of the rotor 1, is referred to as an “axial direction”. The circumferential direction about the axis C1 is referred to as a “circumferential direction”. The radial direction about the axis C1 is referred to as a “radial direction”. The rotating direction of the rotor 1 is set to be counterclockwise in FIG. 1 and indicated by the arrow R1 in FIG. 1 and other figures.

### (Configuration of Stator)

The stator 5 includes a stator core 50 and coils 55 wound on the stator core 50. The stator core 50 is formed of steel sheets which are stacked in the axial direction and fixed together by crimping or the like. Each steel sheet is, for example, an electromagnetic steel sheet. The thickness of the steel sheet is, for example, 0.1 to 0.7 mm, and 0.35 mm in this example.

The stator core 50 has a yoke 51 having an annular shape about the axis C1 and a plurality of teeth 52 extending inward in the radial direction from the yoke 51. An outer circumference of the yoke 51 is fixed to an inner side of the shell 6.

The teeth 52 are formed at equal intervals in the circumferential direction. The number of teeth 52 is nine in this example, but only needs to be three or more. A slot for housing the coil 55 is formed between adjacent teeth 52. The coil 55 is wound around the tooth 52 of the stator core 50 via an insulating part 54. The coil 55 is composed of a material such as copper or aluminum.

The stator core 50 has a plurality of split cores 50A divided so that each split core 50A includes one tooth 52. The number of split cores 50A is, for example, nine. These split cores 50A are joined and coupled together in the circumferential direction by split surfaces 58 formed in the yoke 51. Meanwhile, the stator core 50 is not limited to the configuration in which the plurality of split cores 50A are coupled together.

The insulating part 54 is provided between the stator core 50 and the coil 55. The insulating part 54 is formed of, for example, an insulator disposed at an end of the stator core 50 in the axial direction and an insulating film disposed at an inner surface of the slot.

The coil 55 is formed of, for example, a magnet wire, and wound around the tooth 52 via the insulating part 54. The wire diameter of the coil 55 is, for example, 0.8 mm. The coil 55 is wound around each tooth 52 in concentrated winding in, for example, 70 turns. Meanwhile, the wire diameter and the number of turns of the coil 55 are determined depending on the required rotation speed, torque, or applied voltage, or the sectional area of the slot.

Crimping portions 56 and 57 are formed in the yoke 51. The crimping portions 56 and 57 are used to fix the plurality of steel sheets of the stator core 50 in the axial direction. The crimping portion 56 is formed on a straight line in the radial direction that passes the center of the tooth 52 in the circumferential direction. The crimping portions 57 are formed at two locations that are symmetric in the circumferential direction with respect to the straight line. However, the number and arrangement of the crimping portions 56 and 57 can be changed as necessary.

Concave portions 59 are formed at an outer circumference of the yoke 51. A refrigerant passage in the compressor 300 is formed between the concave portion 59 and the shell 6.

### (Configuration of Rotor)

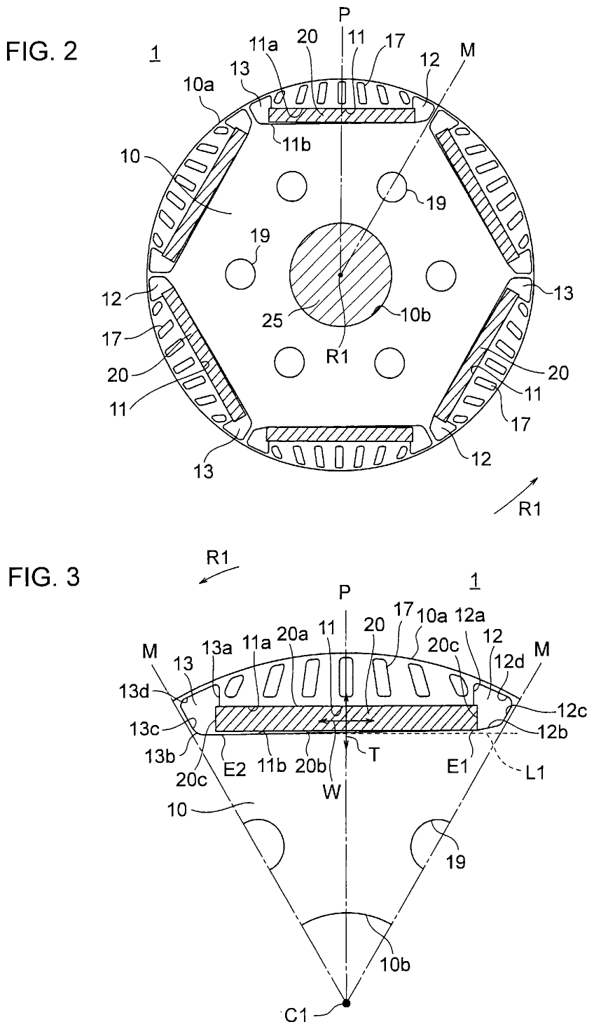

FIG. 2 is a sectional view illustrating the rotor 1. The rotor 1 has a rotor core 10 having an annular shape about the axis C1, the permanent magnets 20 fixed to the rotor core 10, and a shaft 25 fixed to an inner circumference 10b of the rotor core 10. The center axis of the shaft 25 is the axis C1 described above.

The rotor core 10 is formed of steel sheets which are stacked in the axial direction and integrated together by crimping or the like. Each steel sheet is, for example, an electromagnetic steel sheet. The thickness of the steel sheet is, for example, 0.1 to 0.7 mm, and 0.35 mm in this example. The shaft 25 is fixed to the inner circumference 10b of the rotor core 10 by shrink-fitting or press-fitting.

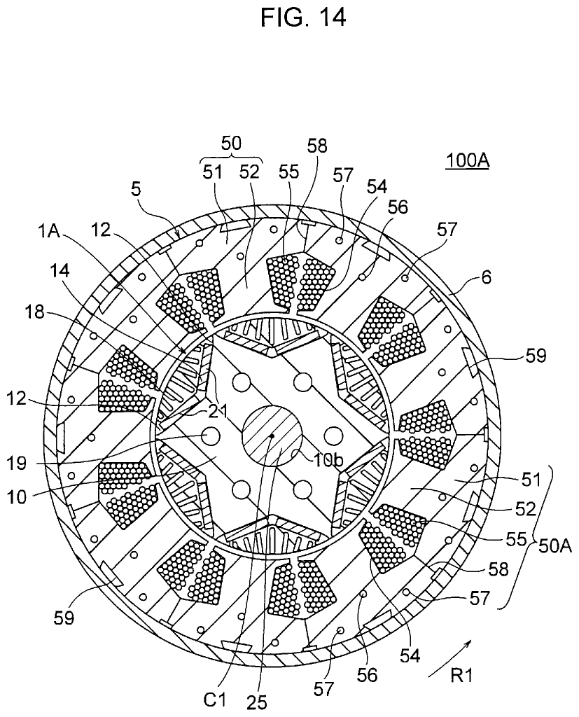

A plurality of magnet insertion holes 11 are formed along an outer circumference 10a of the rotor core 10. The plurality of magnet insertion holes 11 are formed at equal intervals in the circumferential direction. The magnet insertion hole 11 reaches from one end to the other end of the rotor core 10 in the axial direction. The magnet insertion hole 11 extends linearly in a plane perpendicular to the axis C1. Meanwhile, the magnet insertion hole 11 may have a V-shape (see FIG. 14).

One permanent magnet 20 is disposed in each magnet insertion hole 11. Each magnet insertion hole 11 corresponds to one magnetic pole. The number of magnet insertion holes 11 is six in this example, and therefore the number of magnetic poles is six. Meanwhile, the number of magnetic poles is not limited to six, but only needs to be two or more. The permanent magnets 20 adjacent to each other in the circumferential direction have opposite poles on their outer side in the radial direction.

The permanent magnet 20 is a member having a flat plate shape. The permanent magnet 20 is composed of, for example, a neodymium rare earth magnet that contains neodymium (Nd), iron (Fe), and boron (B).

The neodymium rare earth magnet has characteristics such that its coercive force decreases as temperature increases. When the motor 100 is used in the compressor 300, the temperature of the permanent magnet 20 reaches 100° C. or higher, and its coercive force decreases at a decreasing rate of −0.5 to −0.6%/K depending on the temperature. For this reason, dysprosium (Dy) may be added to the permanent magnet 20 to improve the coercive force.

However, when Dy is added to the permanent magnet 20, the residual magnetic flux density of the permanent magnet 20 decreases. As the residual magnetic flux density decreases, the magnet torque of the motor 100 decreases and the current required to generate the desired torque increases, with the result that copper loss increases. In order to improve the motor efficiency, it is desirable that the adding amount of Dy is as little as possible.

Holes 19, which serve as refrigerant passages, are formed on the inner side of the magnet insertion holes 11 in the radial direction. In this example, the holes 19 are formed at positions corresponding to inter-pole portions, but the arrangement of the holes 19 is not limited. The rotor core 10 may also be configured to have no hole 19.

The center of the magnet insertion hole 11 in the circumferential direction is a pole center P. A straight line in the radial direction that passes through the pole center P is referred to as a magnetic pole center line. The boundary between adjacent magnetic poles is an inter-pole portion M. The magnet insertion hole 11 extends in a direction perpendicular to the magnetic pole center line.

Slits 17 are formed on the outer side of the magnet insertion hole 11 in the radial direction. The slits 17 are used to smooth the distribution of magnetic flux from the permanent magnet 20 toward the stator 5 and to suppress torque pulsation. In this example, seven slits 17 are formed symmetrically with respect to the pole center P, but the number and arrangement of the slits 17 are not limited. The rotor core 10 may also be configured to have no slit 17.

An opening 12 is formed on one end of each magnet insertion hole 11 in the circumferential direction. An opening 13 is formed on the other end of each magnet insertion hole 11 in the circumferential direction. The opening 12 is disposed upstream in the rotating direction of the rotor 1, while the opening 13 is disposed downstream in the rotating direction of the rotor 1. The opening 12 is also referred to as a first opening, and the opening 13 is also referred to as a second opening.

FIG. 3 is a diagram illustrating a region corresponding to one magnetic pole of the rotor 1, i.e., a region including one magnet insertion hole 11. The permanent magnet 20 has a magnetic pole surface 20a on the outer side in the radial direction, a magnetic pole surface 20b on the inner side in the radial direction, and both end surfaces 20c in the circumferential direction. The magnetic pole surface 20a is also referred to as a first magnetic pole surface, while the magnetic pole surface 20b is also referred to as a second magnetic pole surface. The magnetic pole surfaces 20a and 20b extend in a direction perpendicular to the magnetic pole center line.

The permanent magnet 20 has a flat plate shape. The permanent magnet 20 has a length in the axial direction, and has a thickness and a width in a plane perpendicular to the axial direction. The length of the permanent magnet 20 in the axial direction is, for example, 30 to 40 mm. The thickness of the permanent magnet 20 is, for example, 2 mm. The width of the permanent magnet 20 is, for example, 20 mm.

The thickness direction of the permanent magnet 20 is referred to as a magnet thickness direction T. The magnet thickness direction T is the magnetization direction of the permanent magnet 20. The magnet thickness direction T can also be said to be the direction perpendicular to the magnetic pole surface 20a of the permanent magnet 20. In the first embodiment, the magnet thickness direction T is parallel to the magnetic pole center line.

The widthwise direction of the permanent magnet 20 is referred to as a magnet widthwise direction W. The magnet widthwise direction W is the direction parallel to the magnetic pole surface 20a in a plane perpendicular to the axial direction. The direction in which the magnet insertion hole 11 extends coincides with the magnet widthwise direction W. In the first embodiment, the magnet widthwise direction W is perpendicular to the magnetic pole center line.

A corner between the magnetic pole surface 20a and the end surface 20c of the permanent magnet 20 and a corner between the magnetic pole surface 20b and the end surface 20c of the permanent magnet 20 are desirably rounded (imparted with curvatures) in order to prevent chipping of the corners when the permanent magnet 20 makes contact with surroundings during insertion into the magnet insertion hole 11.

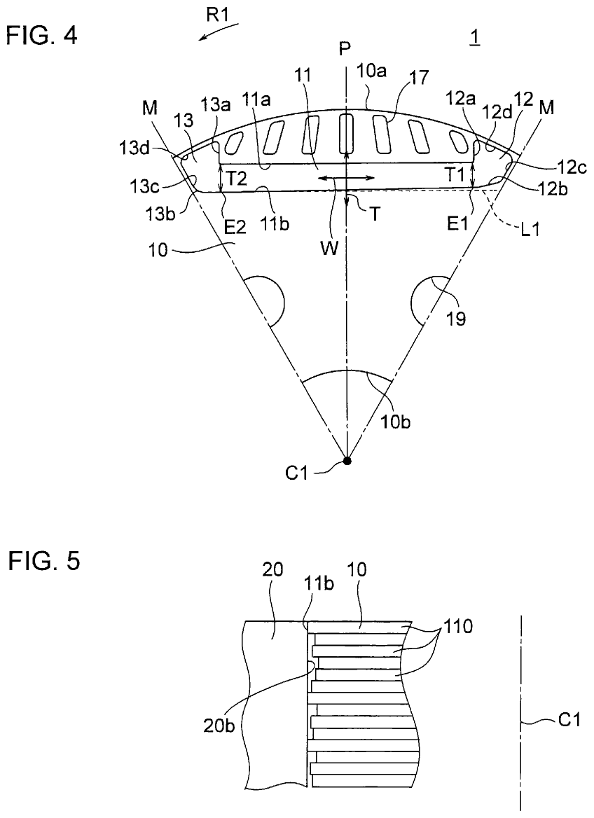

FIG. 4 is a diagram illustrating a region corresponding to one magnetic pole of the rotor core 10. The magnet insertion hole 11 has an outer end edge 11a on the outer side in the radial direction and an inner end edge 11b on the inner side in the radial direction. The outer end edge 11a extends linearly in the direction perpendicular to the magnetic pole center line. In contrast, the inner end edge 11b extends to be inclined relative to the outer end edge 11a.

The dimension of the magnet insertion hole 11 in the magnet thickness direction T is referred to as an opening dimension. The opening dimension is also a distance between the outer end edge 11a and the inner end edge 11b in the magnet thickness direction T. The end of the magnet insertion hole 11 on the opening 12 side is referred to as an end E1, and the end of the magnet insertion hole 11 on the opening 13 side is referred to as an end E2.

The opening dimension T1 at the end E1 of the magnet insertion hole 11 on the opening 12 side is smaller than the opening dimension T2 at the end E2 of the magnet insertion hole 11 on the opening 13 side (T1<T2).

Specifically, the opening dimension T1 at the end E1 of the magnet insertion hole 11 on the opening 12 side is 2.05 mm, while the opening dimension T2 at the end E2 of the magnet insertion hole 11 on the opening 13 side is 2.2 mm.

The opening dimension T1 corresponds to an opening dimension at one end of the magnet insertion hole 11 in the magnet widthwise direction W. In contrast, the opening dimension T2 corresponds to an opening dimension at a position (in this example, the end E2) distanced from the end of the magnet insertion hole 11 in the magnet widthwise direction W by the width of the permanent magnet 20.

As illustrated in FIG. 3, at the end E2 of the magnet insertion hole 11 on the opening 13 side, a gap is formed between the inner end edge 11b of the magnet insertion hole 11 and the magnetic pole surface 20b of the permanent magnet 20. The gap is, for example, 0.2 mm.

In contrast, at the end E1 of the magnet insertion hole 11 on the opening 12 side, the permanent magnet 20 is in a state of being lightly press-fitted into the magnet insertion hole 11.

FIG. 5 is a schematic diagram illustrating a state where the permanent magnet 20 is lightly press-fitted into the magnet insertion hole 11 at the end E1 of the magnet insertion hole 11 on the opening 12 side. The rotor core 10 is formed of a plurality of steel sheets 110 which are stacked in the axial direction. When the rotor core 10 is viewed in a section parallel to the stacking direction, the end edges of the steel sheets 110 are not aligned.

Consequently, there is a gap of, for example, 0.05 mm in average between the inner end edge 11b of the magnet insertion hole 11 and the magnetic pole surface 20b of the permanent magnet 20. The end edges of some steel sheets 110 are in contact with the magnetic pole surface 20b of the permanent magnet 20. Such a state is referred to as the state of being lightly press-fitted into the magnet insertion hole 11. Thus, the permanent magnet 20 is held at the end E1 of the magnet insertion hole 11 on the opening 12 side.

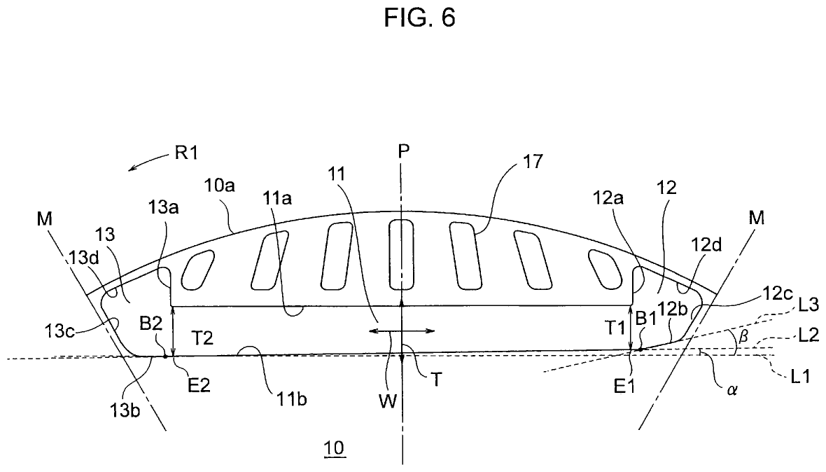

FIG. 6 is an enlarged diagram illustrating the magnet insertion hole 11 and its surroundings. A virtual line parallel to the outer end edge 11a is referred to as a straight line L1. In FIG. 6, a straight line obtained by extending the inner end edge 11b is defined as a straight line L2. The inner end edge 11b is inclined by an angle α relative to the straight line L1. In other words, the inner end edge 11b is inclined by the angle α relative to the outer end edge 11a.

The opening 12 has an outer end edge 12a extending from an end of the outer end edge 11a of the magnet insertion hole 11, an inner end edge 12b extending from an end of the inner end edge 11b, an inter-pole end edge 12c extending from an end of the inner end edge 12b, and an outer circumferential end edge 12d extending to connect the ends of the outer end edge 12a and inter-pole end edge 12c.

In FIG. 6, a straight line obtained by extending the inner end edge 12b is defined as a straight line L3. The inner end edge 12b is inclined by an angle β larger than the angle α, relative to the straight line L1. Thus, when a boundary between the inner end edge 11b and the inner end edge 12b is defined as an end point B1, the permanent magnet 20 does not move toward the opening 12 side beyond the end point B1. That is, the position of the permanent magnet 20 in the magnet widthwise direction W is restricted at the end point B1.

The outer end edge 12a of the opening 12 extends in parallel to the magnetic pole center line. The inter-pole end edge 12c extends in parallel to the straight line in the radial direction that passes through the inter-pole portion M. The outer circumferential end edge 12d extends along the outer circumference of the rotor core 10. However, the extending directions of these end edges 12a, 12c, and 12d are not limited to the examples described herein.

The opening 13 has an outer end edge 13a extending from an end of the outer end edge 11a of the magnet insertion hole 11, an inner end edge 13b extending from an end of the inner end edge 11b, an inter-pole end edge 13c extending from an end of the inner end edge 13b, and an outer circumferential end edge 13d connecting the ends of the outer end edge 13a and the inter-pole end edge 13c.

When a boundary between the inner end edge 11b and the inner end edge 13b is defined as an end point B2, the inner end edge 13b extends from the end point B2 on the same straight line as the inner end edge 11b. In an insertion step of the permanent magnets 20 as described later, the permanent magnet 20 can be inserted into the magnet insertion hole 11 so as to protrude from the end E2 toward the opening 13 side, and then moved toward the end E1.

The outer end edge 13a of the opening 13 extends in parallel to the magnetic pole center line. The inter-pole end edge 13c extends in parallel to the straight line in the radial direction that passes through the inter-pole portion M. The outer circumferential end edge 13d extends along the outer circumference of the rotor core 10. However, the extending directions of these end edges 13a, 13c, and 13d are not limited to the examples described herein.

The end E1 of the magnet insertion hole 11 having a narrower opening dimension T1 is desirably located upstream in the rotating direction of the rotor 1. When the rotor 1 rotates, the permanent magnet 20 in the magnet insertion hole 11 is subjected to inertial force in the direction opposite to the rotating direction. With this inertial force, the permanent magnet 20 is biased toward the end E1 side of the magnet insertion hole 11 and is press-fitted therein more strongly.

### (Manufacturing Method of Rotor)

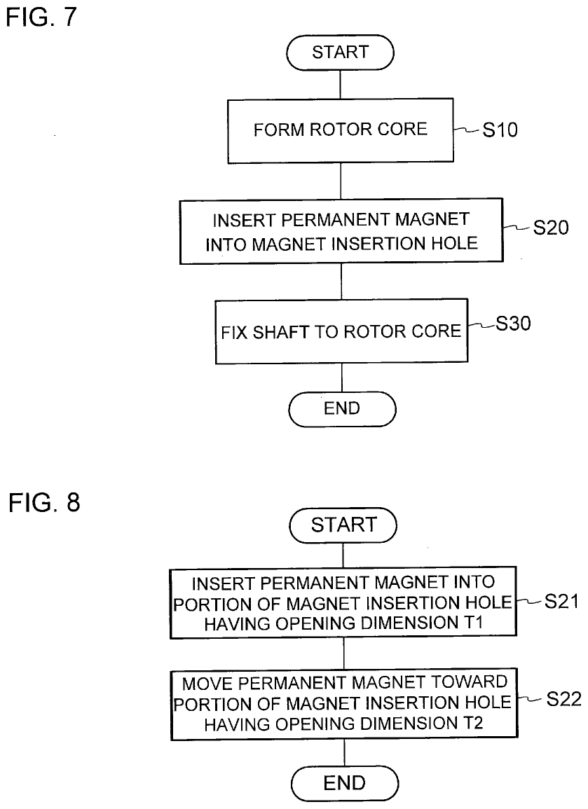

Next, a manufacturing method of the rotor 1 will be described. FIG. 7 is a flowchart illustrating the manufacturing method of the rotor 1. First, a plurality of steel sheets, each of which is stamped in a planer shape illustrated in FIG. 2, are stacked in the axial direction. The stacked steel sheets are fixed integrally by crimping or the like to form the rotor core 10 (step S10). Then, the permanent magnets 20 are inserted in the magnet insertion holes 11 of the rotor core 10 (step S20).

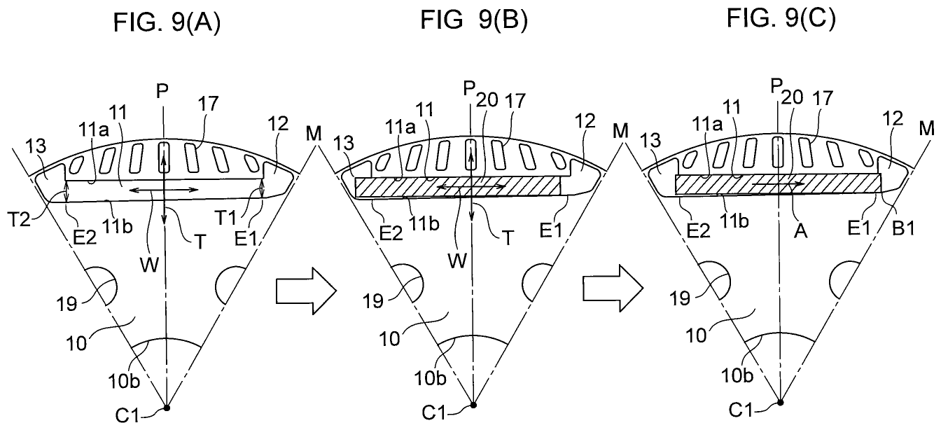

FIG. 8 is a flowchart illustrating the insertion step of the permanent magnet 20. FIGS. 9(A) to 9(C) are schematic diagrams illustrating the insertion step of the permanent magnet 20. As illustrated in FIG. 9(A), the opening dimension T1 at the end E1 of the magnet insertion hole 11 on the opening 12 side is smaller than the opening dimension T2 at the end E2 of the magnet insertion hole 11 on the opening 13 side.

As illustrated in FIG. 9(B), the permanent magnet 20 is first inserted into the end E2 side of the magnet insertion hole 11 that has a wider opening dimension, i.e., the opening 13 side (step S21). The permanent magnet 20 is inserted in the magnet insertion hole 11 so as to protrude toward the opening 13 side.

Then, as indicated by the arrow A in FIG. 9(C), the permanent magnet 20 is moved to the end E1 side of the magnet insertion hole 11 that has a smaller opening dimension, i.e., the opening 12 side (step S22). As the permanent magnet 20 moves toward the opening 12 side, the width of the magnet insertion hole 11 gradually decreases.

By moving the permanent magnet 20 to the opening 12 side, the front end portion of the permanent magnet 20 in the moving direction is brought into the state of being lightly press-fitted between the end edges 11a and 11b of the magnet insertion hole 11. Thus, the permanent magnet 20 is positioned so as not to move within the magnet insertion hole 11.

Since the inner end edge 12b having a larger inclination angle is provided beyond the end point B1 of the inner end edge 11b, the permanent magnet 20 cannot be moved beyond the end point B1 toward the opening 12 side. That is, the position of the permanent magnet 20 in the circumferential direction is restricted at the end point B1.

After the permanent magnets 20 are inserted into the magnet insertion holes 11 in this way, in step S30 in FIG. 7, the shaft 25 is fixed to the inner circumference 10b of the rotor core 10 by shrink-fitting or the like (S30). After the shaft 25 is fixed to the rotor core 10, magnetization of the permanent magnets 20 may be performed. The magnetization of the permanent magnets 20 may be performed using a magnetizing device or may be performed in a state where the rotor 1 is assembled in the stator 5. Alternatively, the shaft 25 may be fixed to the rotor core 10 after the permanent magnets 20 are magnetized.

### (Function)

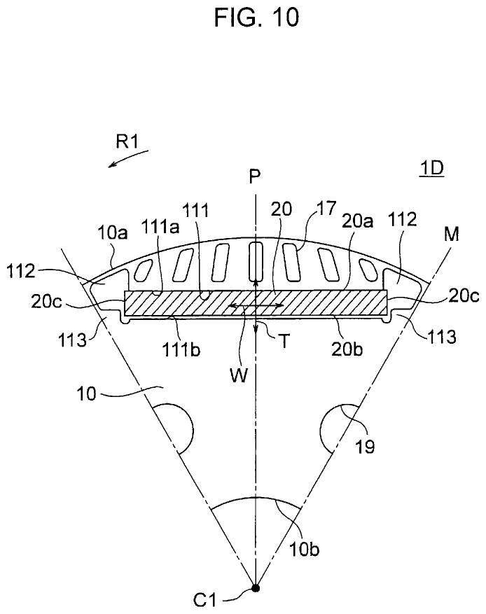

Next, the function of the first embodiment will be described. FIG. 10 is a diagram illustrating a region corresponding to one magnetic pole of a rotor 1D of Comparative Example 1 to be compared with the rotor 1 of the first embodiment. The rotor 1D of Comparative Example 1 differs from the rotor 1 of the first embodiment in the shapes of magnet insertion holes 111 and openings 112.

In Comparative Example 1, the width of the magnet insertion hole 111 in the magnet thickness direction T is constant across the entire magnet insertion hole 111 in the magnet widthwise direction W. That is, an outer end edge 111a and an inner end edge 111b of the magnet insertion hole 111 are parallel to each other. Two openings 112 are formed on both sides of the magnet insertion hole 111 in the circumferential direction. The two openings 112 are symmetrically shaped with respect to the pole center P.

There is a variation in the thickness of the permanent magnet 20 that occurs during processing. In particular, a rare earth magnet is manufactured by cutting a block-shaped sintered magnet into a flat plate shape, and has a dimensional tolerance of approximately 0.2 mm due to machining error. For this reason, the opening dimension of the magnet insertion hole 111 is generally set to be larger than the thickness of the permanent magnet 20. Thus, a gap occurs between the permanent magnet 20 and the magnet insertion hole 111 in the magnet thickness direction T (the magnetization direction of the permanent magnet 20).

This gap serves as an air gap for the magnetic flux exiting from the permanent magnet 20. Thus, the magnetic flux interlinked with the coil 55 of the stator 5 decreases, and the induced voltage in the coil 55 is lowered. As a result, the current required to generate the same output increases, so that copper loss increases and motor efficiency decreases.

If the gap exists between the permanent magnet 20 and the magnet insertion hole 111 as described above, the permanent magnet 20 is more likely to move within the magnet insertion hole 111 and may hit the rotor core 10, causing vibration. Thus, protrusions 113 that are in contact with the end surfaces 20c of the permanent magnet 20 are provided in the magnet insertion hole 111 or the openings 112. When the protrusions 113 are provided in this way, demagnetization of the permanent magnet 20 may occur in the manner described below.

In the motor 100, a larger current than that during a normal operation may flow through the coil 55 of the stator 5. When a large current flows through the coil 55 of the stator 5, the magnetic flux generated by the current in the coil 55 acts on the permanent magnet 20. The magnetic flux flowing through the permanent magnet 20 in the direction opposite to the magnetization direction is referred to as a reverse magnetic flux.

The reverse magnetic flux from the stator 5 tends to flow through a portion of the rotor core 10 where the magnetic resistance is as small as possible. Thus, the reverse magnetic flux proceeds to a thin-walled portion between the opening 112 and the outer circumference 10a of the rotor core 10 while bypassing the magnet insertion hole 111 and the opening 112 where the magnetic resistance is high. However, since the magnetic path in the thin-walled portion is narrow, magnetic saturation occurs when a certain amount of magnetic flux flows through the thin-walled portion, and no magnetic flux flows through the thin-walled portion.

If the protrusions 113 are provided in the magnet insertion hole 111 or the openings 112 as described above, the distance from the outer circumferential region of the rotor core 10 to each protrusion 113 is smaller than the thickness of the permanent magnet 20, and thus the reverse magnetic flux from the stator 5 flows concentratedly to the protrusions 113. Since the protrusions 113 are in contact with the end surfaces 20c of the permanent magnet 20, demagnetization of the permanent magnet 20 may occur at the end surfaces 20c when the reverse magnetic flux is concentrated on the protrusions 113.

Demagnetization of the permanent magnet 20 tends to occur particularly at high temperature. When demagnetization of the permanent magnet 20 occurs, the residual magnetic flux density of the permanent magnet 20 decreases and does not recover even after the reverse magnetic flux disappears. Thus, the demagnetization of the permanent magnet 20 leads to a decrease in the output of the motor 100, and results in deterioration in the performance of the compressor 300 or the air conditioner 400.

In contrast, in the first embodiment, as illustrated in FIG. 4, the opening dimension T1 at one end E1 in the magnet widthwise direction W of the magnet insertion hole 11 is smaller than the opening dimension T2 at the other end E2. Thus, the permanent magnet 20 can be inserted into the end E2 side of the magnet insertion hole 11, and then moved toward the end E1 side.

Since the permanent magnet 20 is held in the state of being lightly press-fitted at the end E1 side of the magnet insertion hole 11, the gap between the permanent magnet 20 and the magnet insertion hole 11 can be made narrower, and thus the magnetic resistance decreases. Thus, the amount of magnetic flux interlinked with the coil 55 of the stator 5 increases. As the amount of magnetic flux interlinked with the coil 55 increases, the amount of current made to flow through the coil 55 for generating the same torque can be reduced, and thus copper loss decreases and the motor efficiency increases.

Since the permanent magnet 20 is held in the state of being lightly press-fitted at the end E1 side of the magnet insertion hole 11 having the opening dimension T1, it is not necessary to provide the protrusion 113 as in Comparative Example 1. The magnet insertion hole 11 is not provided with a portion protruding inside thereof, i.e., a portion on which the reverse magnetic flux from the stator 5 is concentrated, and thus demagnetization of the permanent magnet 20 is less likely to occur.

In the rotor 1 of the first embodiment, the permanent magnet 20 can be positioned without providing a protrusion in the magnet insertion hole 11 as above, and thus demagnetization of the permanent magnet 20 can be suppressed. Further, a gap between the permanent magnet 20 and the magnet insertion hole 11 is small, and thus the motor efficiency can be improved.

If a protrusion is provided in the magnet insertion hole 11 or in the opening 12 or 13, the magnetic flux exiting from the permanent magnet 20 may return to the permanent magnet 20 through the protrusion, i.e., a so-called short-circuit of the magnetic flux may occur. In the first embodiment, it is not necessary to provide a protrusion in the magnet insertion hole 11 or in the opening 12 or 13, and thus the short-circuit of the magnetic flux can be suppressed and the motor efficiency can be enhanced.

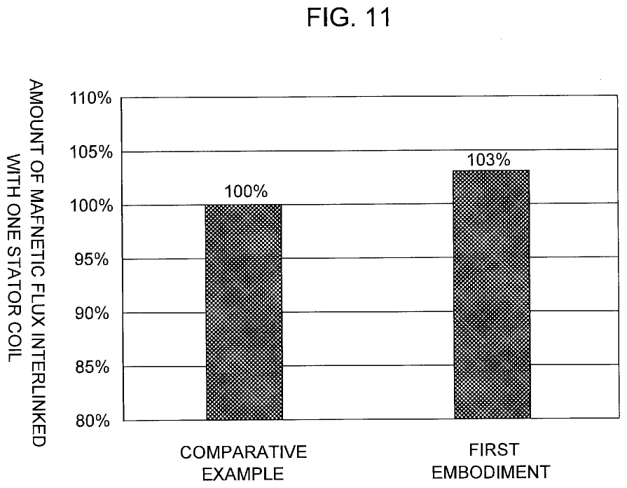

FIG. 11 is a graph illustrating comparison of the amount of magnetic flux interlinked with the coil 5 of the stator 5 between the first embodiment and Comparative Example 1. The vertical axis represents the amount of magnetic flux interlinked with the coil 55 of the stator 5 when each of the rotor 1 of the first embodiment and the rotor 1D of Comparative Example 1 is assembled in the stator 5 (FIG. 1). The amount of magnetic flux is expressed in relative value.

In Comparative Example 1, the amount of magnetic flux interlinked with the coil 55 of the stator 5 is 100%. As can be seen from FIG. 11, the amount of magnetic flux interlinked with the coil 55 of the stator 5 in the first embodiment increases to 103% with respect to 100% in Comparative Example 1.

This is because, in the rotor 1 of the first embodiment, the gap between the permanent magnet 20 and the magnet insertion hole 11 is small, and thus the magnetic resistance decreases and the magnetic flux interlinked with the coil 55 of the stator 5 increases.

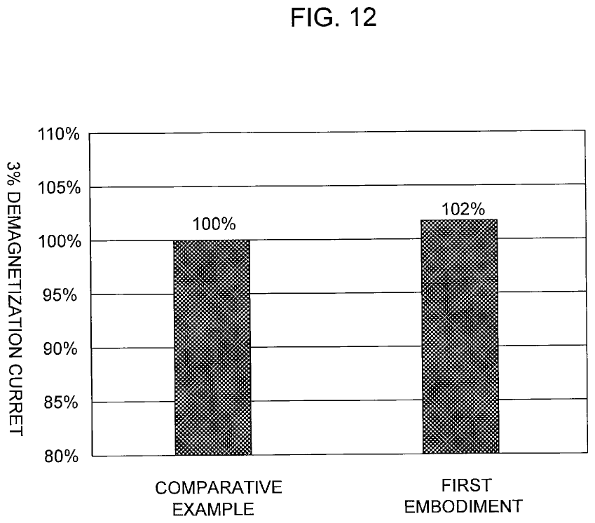

FIG. 12 is a graph illustrating comparison of 3% demagnetization current between the first embodiment and Comparative Example 1. The 3% demagnetization current is a current flowing through the coil 55 when the demagnetization rate of the permanent magnet 20 reaches 3%. The motor 100 is placed in an atmosphere of 140° C. This temperature (140° C.) is the highest temperature at which the motor 100 is used in the compressor 300.

As described above, the demagnetization of the permanent magnet 20 leads to decrease in the output of the motor 100, and results in deterioration in the performance of the compressor 300 or the air conditioner 400. For this reason, it is generally required to suppress the demagnetization rate of the motor 100 to 3% or less. Thus, an inverter circuit that controls the motor 100 is provided with a current cut-off circuit that cuts off the current before the demagnetization rate reaches 3%.

As can be seen from FIG. 12, when the 3% demagnetization current for the rotor 1D of Comparative Example 1 is expressed as 100%, the 3% demagnetization current for the rotor 1 of the first embodiment increases to 102%.

This is because, in the rotor 1 of the first embodiment, no protrusion 113 (FIG. 10) is provided in the magnet insertion hole 11 or the opening 12, and thus there is no portion around the permanent magnet 20 on which the reverse magnetic flux from the stator 5 is concentrated.

Although the gap is generated between the permanent magnet 20 and the magnet insertion hole 11 at the end E2 side of the magnet insertion hole 11, the permanent magnet 20 is held in the state of being lightly press-fitted at the side of the end E1 having the opening dimension T1 of the magnet insertion hole 11. Thus, it is possible to prevent the permanent magnet 20 from rattling in the magnet thickness direction T.

It is desirable that the entire inner end edge 11b of the magnet insertion hole 11 is inclined relative to the straight line L1. However, it is also possible that only a part of the inner end edge 11b is inclined relative to the straight line L1 as long as the opening dimension T1 at the end E1 is smaller than the opening dimension T2 at the end E2.

### (Effects of Embodiment)

As described above, the rotor 1 of the first embodiment includes the annular rotor core 10 having the magnet insertion holes 11, and the permanent magnets 20 disposed in the magnet insertion holes 11. The permanent magnet 20 has the thickness and the width in a plane perpendicular to the axis C1. The magnet insertion hole 11 has the inner end edge 11b inclined relative to the magnet widthwise direction W so that the opening dimension T1 at one end E1 in the circumferential direction is smaller than the opening dimension T2 at the position (in this example, the end E2) distanced from the end E1 by the width W of the permanent magnet 20.

Thus, the permanent magnet 20 can be inserted into the end E2 side of the magnet insertion hole 11 having the larger opening dimension and then moved toward the end E1 having the smaller opening dimension, whereby the permanent magnet 20 can be positioned within the magnet insertion hole 11.

Therefore, it is not necessary to provide a protrusion for positioning the permanent magnet 20 in the magnet insertion hole 11 or the opening 12, and thus it is possible to suppress the demagnetization of the permanent magnet 20 caused by the reverse magnetic flux from the stator 5 concentrated on the protrusion. Further, since the gap between the permanent magnet 20 and the magnet insertion hole 11 can be made smaller, the amount of magnetic flux interlinked with the coil 55 of the stator 5 can be increased and the motor efficiency can be improved.

The outer end edge 11a of the magnet insertion hole 11 extends linearly and perpendicularly to the magnet thickness direction T. Thus, the magnetic flux distribution in a region outside the magnet insertion hole 11 in the radial direction is made symmetrical with respect to the pole center, so that the surface magnetic flux distribution of the rotor 1 can be made closer to a sinusoidal wave. Consequently, the high-frequency component of the surface magnetic flux of the rotor 1 can be reduced and vibration and noise can be reduced.

Part of the plurality of steel sheets 110 contact the permanent magnet 20 at the end E1 of the magnet insertion hole 11, and thus the permanent magnet 20 can be positioned so as not to move within the magnet insertion hole 11.

The inner end edge 12b of the opening 12 is formed continuously with the inner end edge 11b of the magnet insertion hole 11. The angle β formed between the inner end edge 11b and the outer end edge 11a is larger than the angle α formed between the inner end edge 12b and the outer end edge 11a. Thus, the position of the permanent magnet 20 in the magnet widthwise direction W can be restricted at the end point B1 which is the boundary between the inner end edge 11b and the inner end edge 12b.

Since the end E1 of the magnet insertion hole 11 is located upstream in the rotating direction of the rotor 1, the permanent magnet 20 is pressed against the end E1 of the magnet insertion hole 11 due to the inertia force acting on the permanent magnet 20 when the rotor 1 rotates. Thus, the permanent magnet 20 can be surely positioned within the magnet insertion hole 11.

### Modification

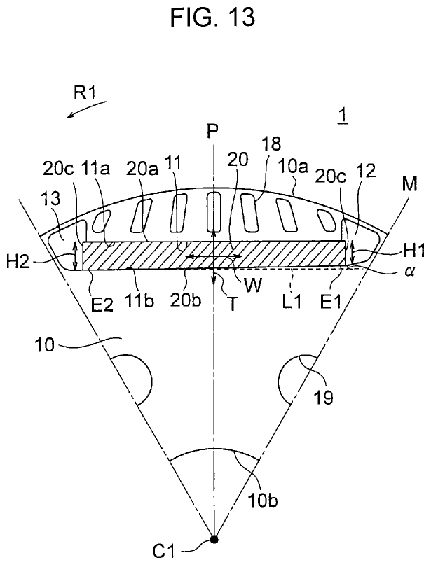

FIG. 13 is a diagram illustrating a region corresponding to one magnetic pole of a rotor 1 of a modification of the first embodiment. This modification differs from the first embodiment in the shape of the permanent magnet 20. The shape of the magnet insertion hole 11 is the same as that of the magnet insertion hole 11 (FIG. 4) of the first embodiment.

That is, in this modification, a thickness H1 of the permanent magnet 20 at the opening 12 side is narrower than a thickness H2 of the permanent magnet 20 at the opening 13 side. The magnetic pole surface 20a of the permanent magnet 20 is perpendicular to the magnet thickness direction T, and the magnetic pole surface 20b is inclined relative to the magnet thickness direction T. The magnetic pole surface 20a of the permanent magnet 20 is parallel to the straight line L1, and the magnetic pole surface 20b is inclined relative to the straight line L1.

An inclination angle of the magnetic pole surface 20b of the permanent magnet 20 relative to the straight line L1 is desirably the same as the inclination angle (the angle α) of the inner end edge 11b of the magnet insertion hole 11 relative to the straight line L1.

In this modification, since the permanent magnet 20 is inclined similarly to the magnet insertion hole 11, the gap between the permanent magnet 20 and the magnet insertion hole 11 can be made smaller, and thus the magnetic resistance can be reduced and the motor efficiency can be improved.

As the permanent magnet 20 is brought into the state of being lightly press-fitted within a wide range of the magnet insertion hole 11, the permanent magnet 20 can be surely positioned within the magnet insertion hole 11.

In particular, if the inclination angle of the magnetic pole surface 20b of the permanent magnet 20 relative to the straight line L1 is the same as the inclination angle of the inner end edge 11b of the magnet insertion hole 11 relative to the straight line L1, the gap between the permanent magnet 20 and the magnet insertion hole 11 can be minimized, further improving the motor efficiency. As the permanent magnet 20 is brought into the state of being lightly press-fitted within a wide range of the magnet insertion hole 11, the permanent magnet 20 can be more surely positioned within the magnet insertion hole 11.

An insertion method of the permanent magnet 20 into the magnet insertion hole 11 is as described with reference to FIGS. 8 and 9(A) to 9(C).

The rotor 1 of the modification is configured in a similar manner to the rotor 1 of the first embodiment in other respects.

As described above, according to this modification, one end of the permanent magnet 20 in the magnet widthwise direction W has the thickness H1, while the other end of the permanent magnet 20 has the thickness H2 (>H1). Thus, the gap between the permanent magnet 20 and the magnet insertion hole 11 can be made smaller. Therefore, the motor efficiency can be improved, and the permanent magnet 20 can be more surely positioned within the magnet insertion hole 11.

### Second Embodiment

Next, a second embodiment will be described. FIG. 14 is a sectional view illustrating a motor 100A of a second embodiment. The motor 100A of the second embodiment differs from the motor 100 of the first embodiment in that a rotor 1A has V-shaped magnet insertion holes 14. The stator 5 of the second embodiment is configured in a similar manner to the stator 5 of the first embodiment.

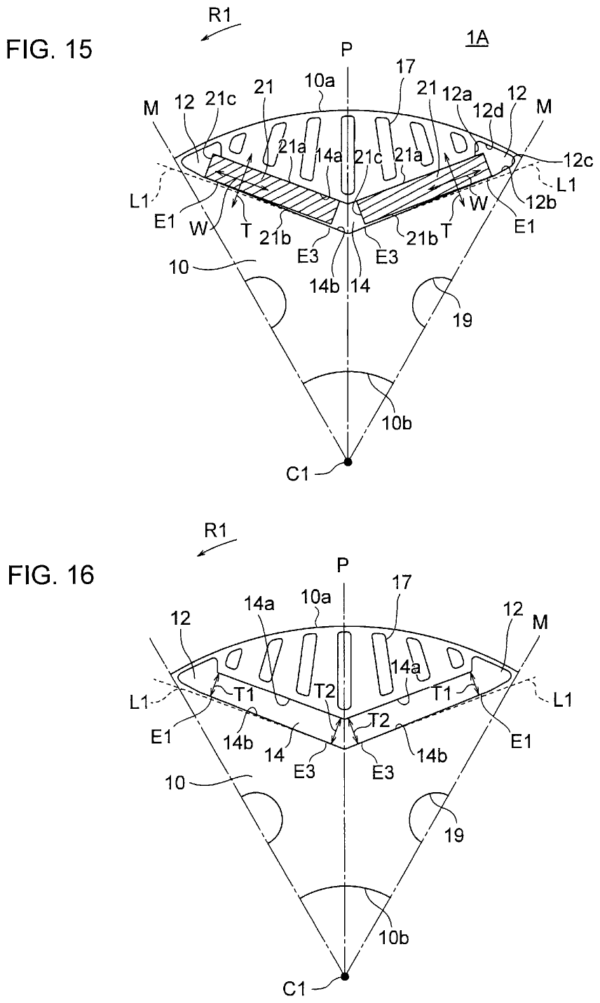

FIG. 15 is a diagram illustrating a region corresponding to one magnetic pole of the rotor 1A of the second embodiment. The rotor core 10 of the rotor 1A is provided with the V-shaped magnet insertion holes 14. A center of each magnet insertion hole 14 in the circumferential direction is convex toward the inner circumference 10b side. The magnet insertion hole 14 has a shape that is symmetrical in the circumferential direction with respect to the center in the circumferential direction.

In each magnet insertion hole 14, two permanent magnets 21 are disposed on both sides of the center of the magnet insertion hole 14 in the circumferential direction. The magnetization directions of the two permanent magnets 21 are in the same direction. Each magnet insertion hole 14 constitutes one magnetic pole. The center of the magnet insertion hole 14 in the circumferential direction corresponds to the pole center P.

Each permanent magnet 21 has a magnetic pole surface 21a on the outer side in the radial direction, a magnetic pole surface 21b on the inner side in the radial direction, and both end surfaces 21c in the circumferential direction. The magnetic pole surfaces 21a and 21b are inclined relative to the magnetic pole center line.

The thickness direction of the permanent magnet 21 is referred to as a magnet thickness direction T. The magnet thickness direction T is the magnetization direction of the permanent magnet 21. The magnet thickness direction T is a direction perpendicular to the magnetic pole surface 21a of the permanent magnet 21.

The widthwise direction of the permanent magnet 21 is referred to as a magnet widthwise direction W. The magnet widthwise direction W is the direction parallel to the magnetic pole surface 21a in a plane perpendicular to the axial direction. In the second embodiment, the magnet thickness direction T and the magnet widthwise direction W are inclined relative to the magnetic pole center line.

FIG. 16 is a diagram illustrating a region corresponding to one magnetic pole of the rotor core 10. The opening 12 is formed on each of both sides of the magnet insertion hole 14 in the circumferential direction. The two openings 12 are symmetrically shaped with respect to the magnetic pole center P.

The magnet insertion hole 14 has a shape in which the opening dimension T1 in the magnet thickness direction T at each end of the magnet insertion hole 14 in the circumferential direction is smaller than the opening dimension T2 in the magnet thickness direction T at the center of the magnet insertion hole 14 in the circumferential direction.

In other words, the magnet insertion hole 14 has a shape in which the opening dimension T1 in the magnet thickness direction T at the end E1 in the magnet widthwise direction W is smaller than the opening dimension T2 in the magnet thickness direction T at a position E3 distanced from the end E1 by the width of the permanent magnet 21.

The magnet insertion hole 14 has an outer end edge 14a on the outer side in the radial direction and an inner end edge 14b on the inner side in the radial direction. Each of the outer end edge 14a and the inner end edge 14b extends in a V-shape so that its center in the circumferential direction is convex toward the inner circumference 10b side.

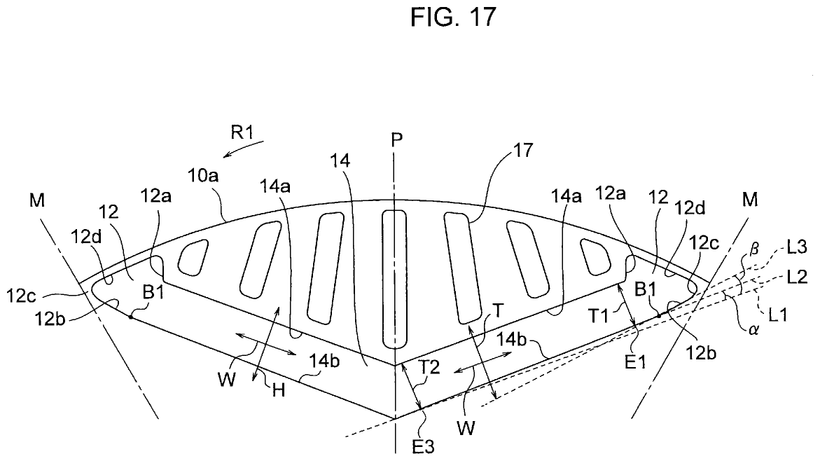

FIG. 17 is an enlarged diagram illustrating the magnet insertion hole 14. A straight line parallel to the outer end edge 14a is referred to as a reference line L1. In FIG. 17, a straight line obtained by extending the inner end edge 14b is defined as a straight line L2. The inner end edge 14b is inclined by an angle α relative to the reference line L1. In other words, the inner end edge 14b is inclined by the angle α relative to the outer end edge 14a.

The shape of the opening 12 is as described in the first embodiment. The opening 12 has the outer end edge 12a, the inner end edge 12b, the inter-pole end edge 12c, and the outer circumferential end edge 12d. The inner end edge 12b of the opening 12 extends from the end point B1 of the inner end edge 14b of the magnet insertion hole 14.

In FIG. 17, a straight line obtained by extending the inner end edge 12b is defined as a straight line L3. An angle β formed between the inner end edge 12b of the opening 12 and the straight line L1 is larger than the angle α formed between the inner end edge 14b of the magnet insertion hole 14 and the straight line L1. Thus, the permanent magnet 21 inserted in the magnet insertion hole 14 cannot move to the opening 12 side beyond the end point B1. That is, the position of the permanent magnet 21 is restricted at the end point B1 which is the boundary between the inner end edge 12b of the opening 12 and the inner end edge 14b of the magnet insertion hole 14.

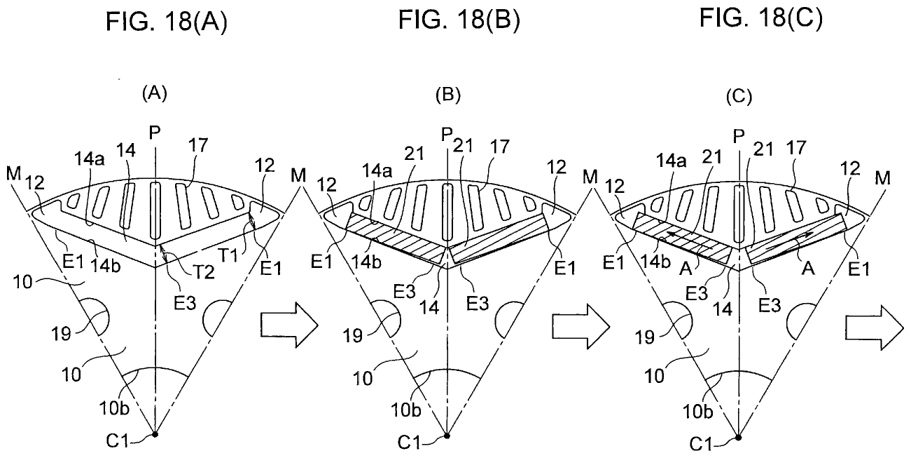

FIGS. 18(A) to 18(C) are schematic diagrams for explaining an insertion method of the permanent magnets 21 in the second embodiment. As described above, in the magnet insertion hole 14, the opening dimension T1 at each end of the magnet insertion hole 14 in the circumferential direction is smaller than the opening dimension T2 at the center of the magnet insertion hole 14 in the circumferential direction as illustrated in FIG. 18(A).

First, as illustrated in FIG. 18(B), two permanent magnets 21 are inserted into the magnet insertion hole 14 at its center side in the circumferential direction, i.e., at the position E3 side having the larger opening dimension.

The magnetization directions of the two permanent magnets 21 are in the same direction, and a magnetic repulsive force acts between the permanent magnets 21. Thus, as illustrated in FIG. 18(C), each of the two permanent magnets 21 is moved to the corresponding end E1 side of the magnet insertion hole 14, i.e., the opening 12 side as indicated by the arrow A.

As each permanent magnet 21 is moved to the corresponding opening 12 side, the front end portion of the permanent magnet 21 in the moving direction is brought into a state of being lightly press-fitted between the end edges 14a and 14b of the magnet insertion hole 14. Thus, the permanent magnets 21 can be positioned so as not to move within the magnet insertion hole 14.

Since the two permanent magnets 21 can be moved using the magnetic repulsive force in this way, an insertion work of the permanent magnets 21 can be facilitated.

The rotor 1A of the second embodiment is configured in a similar manner to the rotor 1 of the first embodiment in other respects.

Meanwhile, it is desirable that the inner end edge 14b of the magnet insertion hole 14 is inclined relative to the straight line L1 across the entire region from the center to the end of the magnet insertion hole 14 in the circumferential direction. However, it is also possible that only a part of the inner end edge 14b of the magnet insertion hole 14 is inclined relative to the straight line L1 as long as the opening dimension T1 is smaller than the opening dimension T2.

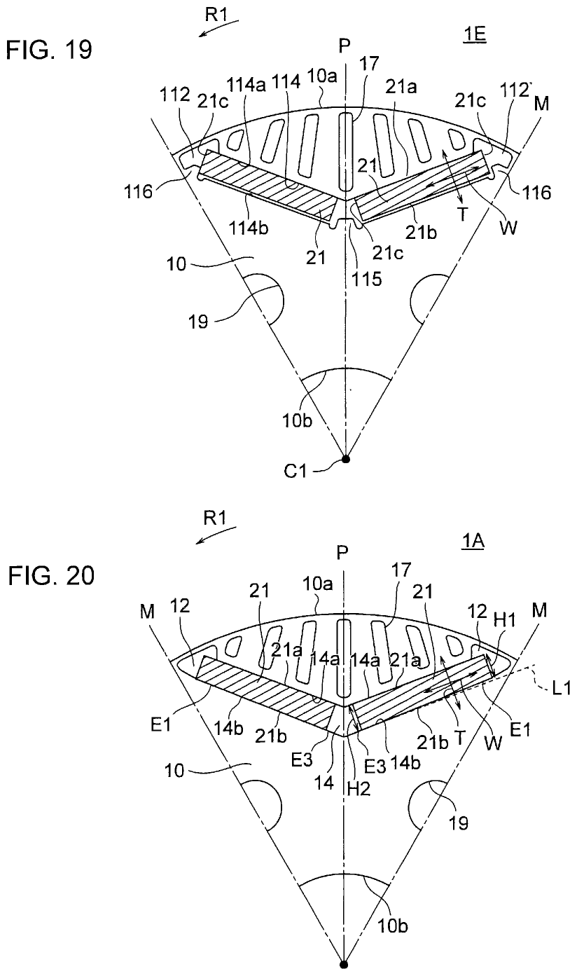

FIG. 19 is a diagram illustrating a region corresponding to one magnetic pole of a rotor 1E of Comparative Example 2 to be compared with the rotor 1A of the second embodiment. The rotor 1E of Comparative Example 2 differs from the rotor 1A of the second embodiment in the shape of a magnet insertion hole 114 and an opening 112.

The magnet insertion hole 114 of Comparative Example 2 has a V-shape such that the center of the magnet insertion hole 114 in the circumferential direction protrudes toward the inner circumference 10b side, but the width of the magnet insertion hole 114 in the magnet thickness direction T is constant. That is, an outer end edge 114a and an inner end edge 114b of the magnet insertion hole 114 are parallel to each other. Two openings 112 which are symmetrically shaped with respect to the pole center P are formed on both sides of the magnet insertion hole 114 in the circumferential direction.

It is necessary to position each permanent magnet 21 so as not to move within the magnet insertion hole 114. Thus, protrusions 116 that are in contact with the end surfaces 21c of the two permanent magnets 21 are formed on both sides of the magnet insertion hole 114 in the circumferential direction. A protrusion 115 that is in contact with the end surfaces 21c of the two permanent magnets 21 is also formed at the center of the magnet insertion hole 114 in the circumferential direction.

As described in the first embodiment, there is a variation in the thickness of the permanent magnet 21, and a gap occurs between the permanent magnet 21 and the magnet insertion hole 114 in the magnet thickness direction T (the magnetization direction of the permanent magnet 21). Since this gap serves as an air gap for the magnetic flux exiting from the permanent magnet 21, the magnetic flux interlinked with the coil 55 of the stator 5 decreases, and the motor efficiency decreases.

In addition, since the protrusions 115 and 116 are provided inside the magnet insertion hole 114 or the opening 112, the reverse magnetic flux from the stator 5 tends to be concentrated on the protrusions 115 and 116. As the protrusions 115 and 116 are in contact with the end surfaces 21c of the permanent magnets 21, demagnetization may occur at the end surfaces 21c of the permanent magnet 21 when the reverse magnetic flux is concentrated on the protrusions 115 and 116.

In contrast, in the second embodiment as illustrated in FIG. 16, the opening dimension T1 at each end of the magnet insertion hole 14 in the circumferential direction is smaller than the opening dimension T2 at the center of the magnet insertion hole 14 in the circumferential direction. Thus, the permanent magnets 21 can be inserted into the center of the magnet insertion hole 14 in the circumferential direction and then moved to the ends of the magnet insertion hole 14 in the circumferential direction as described with reference to FIGS. 18(A) to 18(C).

Since the permanent magnets 21 are held in the state of being lightly press-fitted at the ends of the magnet insertion hole 14 in the circumferential direction, the gap between the permanent magnet 21 and the magnet insertion hole 14 can be made narrower, and thus the magnetic resistance decreases. Thus, the amount of magnetic flux interlinked with the coil 5 of the stator 5 can be increased, and the motor efficiency can be improved.

In the rotor 1A of the second embodiment, the permanent magnets 21 can be positioned without providing protrusions in the magnet insertion hole 14, and thus it is not necessary to provide the protrusions 115 and 116 as in Comparative Example 2. Consequently, the demagnetization of the permanent magnet 21 can be suppressed.

As described above, in the rotor 1A of the second embodiment, the magnet insertion hole 14 has a V-shape, and the opening dimension T1 at the end of the magnet insertion hole 14 in the circumferential direction (the end E1) is smaller than the opening dimension T2 at the center of the magnet insertion hole 14 in the circumferential direction (in other words, the position E3 distanced from the end of the magnet insertion hole 14 in the circumferential direction by the width W of the permanent magnet 21). Thus, the permanent magnets 21 can be held within the magnet insertion hole 14 by inserting the permanent magnets 21 into the center of the magnet insertion hole 14 in the circumferential direction and then moving the permanent magnets 21 toward both ends of the magnet insertion hole 14 in the circumferential direction.

Accordingly, it is not necessary to provide protrusions for positioning the permanent magnets 21 in the magnet insertion hole 14, and thus the demagnetization of the permanent magnets 21 can be suppressed. Further, the gap between the permanent magnet 21 and the magnet insertion hole 14 can be made smaller. Thus, the amount of magnetic flux interlinked with the coil 55 of the stator 5 increases, and the motor efficiency can be improved.

When the permanent magnets 21 are inserted into the magnet insertion hole 14, the permanent magnets 21 can be moved by means of the magnetic repulsive force between the two permanent magnets 21, and thus the insertion work can be simplified.

### Modification

FIG. 20 is a diagram illustrating a region corresponding to one magnetic pole of a rotor 1A of a modification of the second embodiment. This modification differs from the second embodiment in the shape of the permanent magnet 21. The shape of the magnet insertion hole 14 is the same as that of the magnet insertion hole 14 (FIG. 16) of the second embodiment.

In this modification, a thickness H1 at the end of the permanent magnet 21 in the circumferential direction (one end in the magnet widthwise direction W) is smaller than a thickness H2 at the center of the permanent magnet 21 in the circumferential direction (the other end in the magnet widthwise direction W). The magnetic pole surface 21a of the permanent magnet 21 is perpendicular to the magnet thickness direction T, and the magnetic pole surface 21b is inclined relative to the magnet thickness direction T. The magnetic pole surface 21a of the permanent magnet 21 is parallel to the straight line L1, and the magnetic pole surface 21b is inclined relative to the straight line L1.

An inclination angle of the magnetic pole surface 21b of the permanent magnet 21 relative to the straight line L1 is desirably the same as the inclination angle (the angle α illustrated in FIG. 17) of the inner end edge 14b of the magnet insertion hole 14 relative to the straight line L1.

In this modification, since each permanent magnet 21 is inclined similarly to the magnet insertion hole 14, the gap between the permanent magnet 21 and the magnet insertion hole 14 can be made smaller, and thus the magnetic resistance can be reduced and the motor efficiency can be improved. As the permanent magnets 21 are brought into the state of being lightly press-fitted within a wide range of the magnet insertion hole 14, the permanent magnets 21 can be surely positioned within the magnet insertion hole 14.

In particular, if the inclination angle of the magnetic pole surface 21b of the permanent magnet 21 relative to the straight line L1 is the same as the inclination angle of the inner end edge 14b of the magnet insertion hole 14 relative to the straight line L1, the gap between the permanent magnet 21 and the magnet insertion hole 14 can be minimized, and thus the motor efficiency can be further improved. In addition, the permanent magnet 21 can be more surely positioned within the magnet insertion hole 14.

The insertion method of the permanent magnets 21 into the magnet insertion hole 14 is as described with reference to FIGS. 18(A) to 18(C).

The rotor 1A of the modification is configured in a similar manner to the rotor 1A of the second embodiment in other respects.

As described above, according to this modification, one end of the permanent magnet 21 in the magnet widthwise direction W has the thickness H1, while the other end of the permanent magnet 21 has the thickness H2 (>H1). Thus, the gap between the permanent magnet 21 and the magnet insertion hole 14 can be made smaller. Accordingly, the motor efficiency can be improved, and the permanent magnets 21 can be surely positioned within the magnet insertion hole 11.

### Third Embodiment

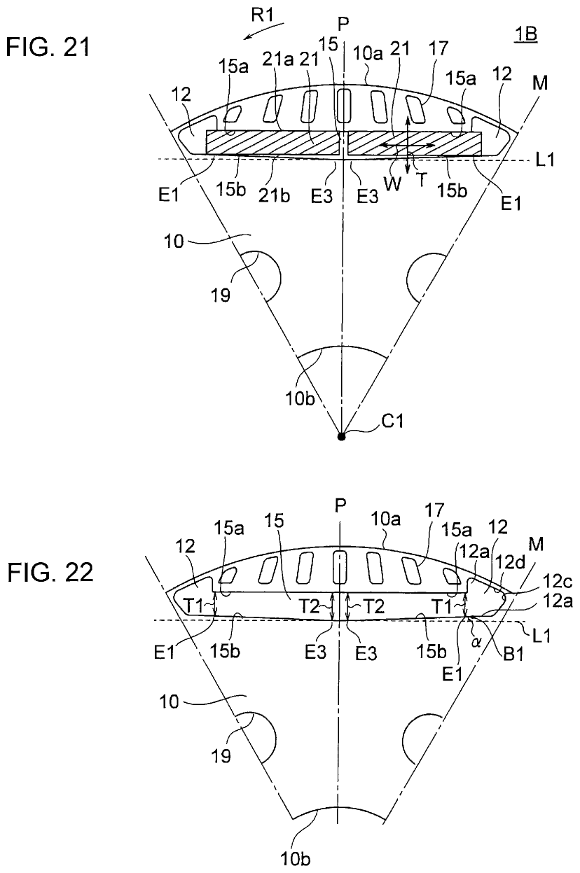

Next, a third embodiment will be described. FIG. 21 is a diagram illustrating a region corresponding to one magnetic pole of a rotor 1B of the third embodiment. The rotor 1B of the third embodiment differs from the rotor 1A of the second embodiment in that the rotor 1B has a linear magnet insertion hole 15. The stator 5 of the third embodiment is configured in a similar manner to the stator 5 of the first embodiment.

The rotor core 10 of the rotor 1B is provided with the magnet insertion holes 15 each of which extends linearly in the plane perpendicular to the axial direction. In one magnet insertion hole 15, two permanent magnets 21 are disposed on both sides of the center of the magnet insertion hole 15 in the circumferential direction. The magnetization directions of the two permanent magnets 21 are in the same direction. Each magnet insertion hole 15 constitutes one magnetic pole. The center of the magnet insertion hole 15 in the circumferential direction corresponds to the pole center P.

The permanent magnet 21 has a magnetic pole surface 21a on the outer side in the radial direction, a magnetic pole surface 21b on the inner side in the radial direction, and both end surfaces 21c in the circumferential direction. The magnetic pole surfaces 21a and 21b are perpendicular to the magnetic pole center line.

The thickness direction of the permanent magnet 21 is referred to as a magnet thickness direction T. The magnet thickness direction T is the magnetization direction of the permanent magnet 21. The magnet thickness direction T is a direction perpendicular to the magnetic pole surface 21a of the permanent magnet 21. The magnet thickness direction T is parallel to the magnetic pole center line.

The widthwise direction of the permanent magnet 21 is referred to as a magnet widthwise direction W. The magnet widthwise direction W is a direction parallel to the magnetic pole surface 21a in a plane perpendicular to the axial direction. The magnet widthwise direction W is perpendicular to the magnetic pole center line.

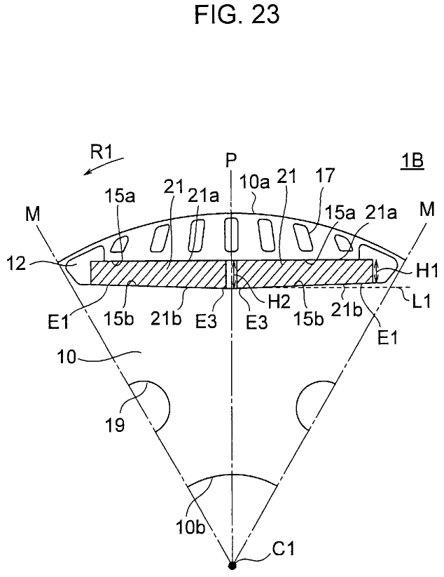

FIG. 22 is a diagram illustrating a region corresponding to one magnetic pole of the rotor core 10. The opening 12 is formed on each of both sides of the magnet insertion hole 15 in the circumferential direction. The two openings 12 are symmetrically shaped with respect to the magnetic pole center P.

The magnet insertion hole 15 has a shape in which the opening dimension T1 in the magnet thickness direction T at each end of the magnet insertion hole 15 in the circumferential direction is smaller than the opening dimension T2 in the magnet thickness direction T at the center of the magnet insertion hole 15 in the circumferential direction.

In other words, the magnet insertion hole 15 has a shape in which the opening dimension T1 in the magnet thickness direction T at the end E1 in the magnet widthwise direction W is smaller than the opening dimension T2 in the magnet thickness direction T at the position E3 distanced from the end E1 by the width of the permanent magnet 21.

The magnet insertion hole 15 has an outer end edge 15a on the outer side in the radial direction and an inner end edge 15b on the inner side in the radial direction. The outer end edge 15a is perpendicular to the magnetic pole center line. A straight line parallel to the outer end edge 15a is referred to as a reference line L1.

The inner end edge 15b is inclined by an angle α relative to the reference line L1. In other words, the inner end edge 15b is inclined by the angle α relative to the outer end edge 15a.

The shape of the opening 12 is as described in the first embodiment. The opening 12 has the outer end edge 12a, the inner end edge 12b, the inter-pole end edge 12c, and the outer circumferential end edge 12d. The position of the permanent magnet 21 is restricted at the end point B1 which is the boundary between the inner end edge 12b of the opening 12 and the inner end edge 15b of the magnet insertion hole 15.

The insertion method of the permanent magnets 21 into the magnet insertion hole 15 is as described in the second embodiment. That is, when two permanent magnets 21 are inserted into the center of the magnet insertion hole 15 in the circumferential direction, the two permanent magnets 21 are moved to both ends of the magnet insertion hole 14 in the circumferential direction by the magnetic repulsive force.

Since the permanent magnets 21 are held in the state of being lightly press-fitted at the ends of the magnet insertion hole 15 in the circumferential direction, the gap between the permanent magnet 21 and the magnet insertion hole 15 can be made narrower, and thus magnetic resistance decreases. Thus, the amount of magnetic flux interlinked with the coil 55 of the stator 5 increases, and the motor efficiency can be improved.

Since the permanent magnets 21 can be positioned without providing protrusions in the magnet insertion hole 15, it is possible to suppress demagnetization of the permanent magnet 21 caused by the reverse magnetic flux from the stator 5 concentrated on the protrusions.

The rotor 1B of the third embodiment is configured in a similar manner to the rotor 1A of the second embodiment in other respects.

Meanwhile, the inner end edge 15b of the magnet insertion hole 15 is desirably inclined relative to the straight line L1 across the entire region from the center to the end of the magnet insertion hole 15 in the circumferential direction. However, it is also possible that only a part of the inner end edge 15b of the magnet insertion hole 15 is inclined relative to the straight line L1 as long as the opening dimension T1 is smaller than the opening dimension T2.

As described above, in the rotor 1B of the third embodiment, the magnet insertion hole 15 is linear, and the opening dimension T1 at the end of the magnet insertion hole 15 in the circumferential direction (the end E1) is smaller than the opening dimension T2 at the center of the magnet insertion hole 15 in the circumferential direction (in other words, the position E3 distanced from the end of the magnet insertion hole 15 in the circumferential direction by the width W of the permanent magnet 21). Thus, the permanent magnets 21 can be held within the magnet insertion hole 15 by inserting the permanent magnets 21 into the center of the magnet insertion hole 15 in the circumferential direction and then moving the permanent magnets 21 toward both ends of the magnet insertion hole 15 in the circumferential direction.

Accordingly, it is not necessary to provide protrusions for positioning the permanent magnets 21 in the magnet insertion hole 15, and thus the demagnetization of the permanent magnets 21 can be suppressed. Further, the gap between the permanent magnet 21 and the magnet insertion hole 15 can be made smaller. Thus, the amount of magnetic flux interlinked with the coil 55 of the stator 5 increases, and the motor efficiency can be improved.

When the permanent magnets 21 are inserted into the magnet insertion hole 15, the permanent magnets 21 can be moved by means of the magnetic repulsive force between the two permanent magnets 21, and thus the insertion work can be simplified.

### Modification

FIG. 23 is a diagram illustrating a region corresponding to one magnetic pole of a rotor 1B of a modification of the third embodiment. This modification differs from the third embodiment in the shape of the permanent magnet 21. The shape of the magnet insertion hole 15 is the same as that of the magnet insertion hole 15 (FIG. 22) of the third embodiment.

In this modification, the thickness H1 of the permanent magnet 21 at the end in the circumferential direction (one end in the magnet widthwise direction W) is smaller than the thickness H2 of the permanent magnet 21 at the center of the magnetic insertion hole 15 in the circumferential direction (the other end in the magnet widthwise direction W). The magnetic pole surface 21a of the permanent magnet 21 is perpendicular to the magnet thickness direction T, and the magnetic pole surface 21b is inclined relative to the magnet thickness direction T. The magnetic pole surface 21a of the permanent magnet 21 is parallel to the straight line L1, and the magnetic pole surface 21b is inclined relative to the straight line L1.

The inclination angle of the magnetic pole surface 21b of the permanent magnet 21 relative to the straight line L1 is desirably the same as the inclination angle (the angle α illustrated in FIG. 22) of the inner end edge 15b of the magnet insertion hole 15 relative to the straight line L1.

In this modification, since each permanent magnet 21 is inclined similarly to the magnet insertion hole 15, the gap between the permanent magnet 21 and the magnet insertion hole 15 can be made smaller, and thus the magnetic resistance can be reduced and the motor efficiency can be improved. As the permanent magnets 21 are brought into the state of being lightly press-fitted within a wide range of the magnet insertion hole 15, the permanent magnets 21 can be surely positioned within the magnet insertion hole 15.

In particular, if the inclination angle of the magnetic pole surface 21b of the permanent magnet 21 relative to the straight line L1 is the same as the inclination angle of the inner end edge 15b of the magnet insertion hole 15 relative to the straight line L1, the gap between the permanent magnet 21 and the magnet insertion hole 15 can be minimized, and thus the motor efficiency can be improved. In addition, the permanent magnets 21 can be more surely positioned within the magnet insertion hole 11.

The insertion method of the permanent magnets 21 into the magnet insertion hole 15 is as described in the second embodiment.

The rotor 1B of the modification is configured in a similar manner to the rotor 1B of the third embodiment in other respects.

As described above, according to this modification, one end of the permanent magnet 21 in the magnet widthwise direction W has the thickness H1, while the other end the permanent magnet 21 has the thickness H2 (>H1). Thus, the gap between the permanent magnet 21 and the magnet insertion hole 15 can be made smaller. Therefore, the motor efficiency can be improved, and the permanent magnet 21 can be surely positioned.

### (Compressor)

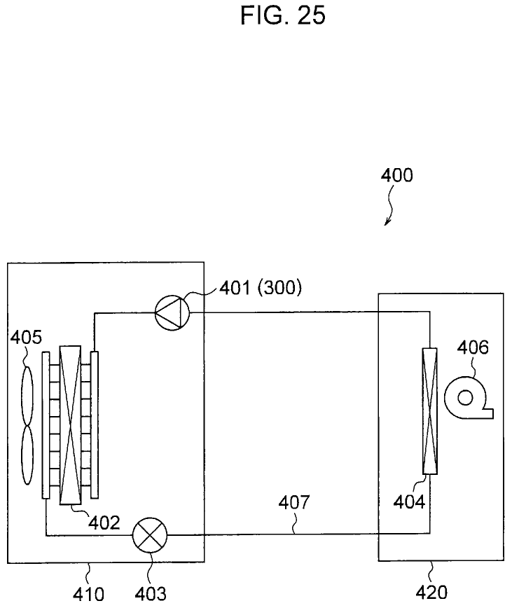

Next, the compressor 300 to which the motors of the first to third embodiments and the modifications are applicable will be described. FIG. 24 is a longitudinal-sectional view of the compressor 300 to which the motors of the first to third embodiments and the modifications are applicable. The compressor 300 is a rotary compressor, and is used, for example, in the air conditioner 400 (FIG. 25).

The compressor 300 includes a compression mechanism part 310, the motor 100 that drives the compression mechanism part 310, the shaft 25 that connects the compression mechanism part 310 and the motor 100, and a closed container 301 that houses these components.

The closed container 301 is a container composed of a steel sheet, and includes a cylindrical shell 6 and a container top that covers the top of the shell 6. The stator 5 of the motor 100 is assembled inside the shell 6 of the closed container 301 by shrink-fitting, press-fitting, welding, or the like.

The container top of the closed container 301 is provided with a discharge pipe 307 for discharging the refrigerant to the outside and terminals 305 for supplying electric power to the motor 100. An accumulator 302 that stores a refrigerant gas is attached to the outside of the closed container 301. At the bottom of the closed container 301, refrigerant oil is retained for lubricating bearings of the compression mechanism part 310.

The compression mechanism part 310 has a cylinder 311 with a cylinder chamber 312, a rolling piston 314 fixed to the shaft 25, a vane dividing the inside of the cylinder chamber 312 into a suction side and a compression side, and an upper frame 316 and a lower frame 317 which close both ends of the cylinder chamber 312 in the axial direction.

Both the upper frame 316 and lower frame 317 have bearings that rotatably support the shaft 25. An upper discharge muffler 318 and a lower discharge muffler 319 are fixed to the upper frame 316 and the lower frame 317, respectively.

The cylinder 311 is provided with the cylinder chamber 312 having a cylindrical shape about the axis C1. An eccentric shaft portion 25a of the shaft 25 is located inside the cylinder chamber 312. The eccentric shaft portion 25a has the center that is eccentric relative to the axis C1. The rolling piston 314 is fitted to the outer circumference of the eccentric shaft portion 25a. When the motor 100 rotates, the eccentric shaft portion 25a and the rolling piston 314 rotate eccentrically within the cylinder chamber 312.

A suction port 313 through which the refrigerant gas is sucked into the cylinder chamber 312 is formed in the cylinder 311. A suction pipe 303 that communicates with the suction port 313 is fixed to the closed container 301, and the refrigerant gas is supplied from the accumulator 302 to the cylinder chamber 312 via the suction pipe 303.

The compressor 300 is supplied with a mixture of a low-pressure refrigerant gas and a liquid refrigerant from a refrigerant circuit of the air conditioner 400 (FIG. 20). If the liquid refrigerant flows into and is compressed by the compression mechanism part 310, it may cause the failure of the compression mechanism part 310. Thus, the accumulator 302 separates the refrigerant into the liquid refrigerant and the refrigerant gas and supplies only the refrigerant gas to the compression mechanism part 310.

For example, R410A, R407C, or R22 may be used as the refrigerant, but it is desirable to use a refrigerant with a low global warming potential (GWP) from the viewpoint of preventing global warming. Examples of the usable low GWP refrigerant are as follows.

(1) First, a halogenated hydrocarbon having a carbon-carbon double bond in its composition, for example, HFO (Hydro-Fluoro-Orefin)-1234yf (CF₃CF═CH₂), can be used. The GWP of HFO-1234yf is 4.

(2) Alternatively, a hydrocarbon having a carbon-carbon double bond in its composition, for example, R1270 (propylene), may be used. The GWP of R1270 is 3, which is lower than that of HFO-1234yf, but R1270 has higher flammability than HFO-1234yf.

(3) A mixture containing at least one of a halogenated hydrocarbon having a carbon-carbon double bond in its composition and a hydrocarbon having a carbon-carbon double bond in its composition may be used. For example, a mixture of HFO-1234yf and R32 may be used. HFO-1234yf described above is a low-pressure refrigerant and thus tends to increase a pressure loss, which may lead to reduction in the performance of the refrigeration cycle (particularly, an evaporator). For this reason, a mixture of the HFO-1234yf with R32 or R41, which is a higher pressure refrigerant than HFO-1234yf, is desirably used in practice.

The operation of the compressor 300 is as follows. The refrigerant gas supplied from the accumulator 302 is supplied through the suction pipe 303 into the cylinder chamber 312 of the cylinder 311. When the motor 100 is driven to rotate the rotor 1, the shaft 25 rotates with the rotor 1. Then, the rolling piston 314 fitted to the shaft 25 eccentrically rotates inside the cylinder chamber 312, and the refrigerant in the cylinder chamber 312 is compressed. The compressed refrigerant passes through the discharge mufflers 318 and 319, further rises inside the closed container 301 through the holes 19 and the like provided in the motor 100, and is then discharged through the discharge pipe 307.

The motors 100 of the first to third embodiments and the modifications have high motor efficiency due to the suppression of demagnetization of the permanent magnets 20. Thus, by using the motor 100 described in any one of the first to third embodiments and the modifications as a driving source of the compressor 300, the operating efficiency of the compressor 300 can be improved.

### (Air Conditioner)

Next, the air conditioner 400 as a refrigeration cycle apparatus including the compressor 300 illustrated in FIG. 24 will be described. FIG. 25 is a diagram illustrating the configuration of the air conditioner 400. The air conditioner 400 includes a compressor 401, a condenser 402, a throttle device (a decompression device) 403, and an evaporator 404.

The compressor 401, the condenser 402, the throttle device 403, and the evaporator 404 are coupled together by a refrigerant pipe 407 to configure the refrigeration cycle. That is, the refrigerant circulates through the compressor 401, the condenser 402, the throttle device 403, and the evaporator 404 in this order.

The compressor 401, the condenser 402, and the throttle device 403 are provided in an outdoor unit 410. The compressor 401 is formed of the compressor 300 illustrated in FIG. 24. The outdoor unit 410 is provided with an outdoor fan 405 that supplies outdoor air to the condenser 402. The evaporator 404 is provided in an indoor unit 420. The indoor unit 420 is provided with an indoor fan 406 that supplies indoor air to the evaporator 404.

The operation of the air conditioner 400 is as follows. The compressor 401 compresses the sucked refrigerant and sends out the compressed refrigerant. The condenser 402 exchanges heat between the refrigerant flowing from the compressor 401 and outdoor air to condense and liquefy the refrigerant and sends out the liquefied refrigerant to the refrigerant pipe 407. The outdoor fan 405 supplies outdoor air to the condenser 402. The throttle device 403 adjusts the pressure or the like of the refrigerant flowing through the refrigerant pipe 407 by changing the opening degree of the throttle device 403.

The evaporator 404 exchanges heat between the refrigerant brought into a low-pressure state by the throttle device 403 and indoor air to cause the refrigerant to remove heat from the air and to evaporate (vaporize), and then sends out the evaporated refrigerant to the refrigerant pipe 407. The indoor fan 406 supplies indoor air to the evaporator 404. Thus, cooled air from which the heat is removed in the evaporator 404 is supplied to the inside of a room.

The air conditioner 400 has the compressor 401 whose operating efficiency is improved by employing the motor 100 described in any of the first to third embodiments and the modifications. Thus, the operating efficiency of the air conditioner 400 can be improved.

Although the desirable embodiments have been specifically described above, various modifications or changes can be made to the above-described embodiments.

1. A rotor comprising:
a rotor core having a magnet insertion hole and having an annular shape about an axis; and
two permanent magnets disposed in the magnet insertion hole, the two permanent magnets being disposed on both sides of a center of the magnet insertion hole in a circumferential direction about the axis, each of the two permanent magnets having a flat plate shape and having a thickness and a width in a plane perpendicular to the axis,
wherein the thickness defines a thickness direction, and the width defines a widthwise direction,
wherein the magnet insertion hole has a portion inclined relative to the widthwise direction so that an opening dimension T1 in the thickness direction at an end of the magnet insertion hole in the widthwise direction is smaller than an opening dimension T2 in the thickness direction at the center of the magnet insertion hole in the circumferential direction, and
wherein a thickness H1 of a portion of each of the two permanent magnets disposed at the end of the magnet insertion hole is narrower than a thickness H2 of a portion of each of the two permanent magnets disposed at the center of the magnet insertion hole.

2. The rotor according to claim 1, wherein the magnet insertion hole has an outer end edge on an outer side in a radial direction about the axis and an inner end edge on an inner side in the radial direction, and
wherein the outer end edge extends linearly from the end of the magnet insertion hole to the position.

3. The rotor according to claim 2, wherein the outer end edge is perpendicular to the thickness direction, and
wherein the inner end edge is inclined relative to the outer end edge.

4. The rotor according to claim 3, wherein an opening is formed to be connected to the end of the magnet insertion hole,
wherein the opening has a continuous end edge continuous to the end at the inner end edge, and
wherein an angle formed between the continuous end edge and the outer end edge is larger than an angle formed between the inner end edge and the outer end edge.

5. The rotor according to claim 1, wherein the rotor core is formed of a stacked body of a plurality of steel sheets stacked in a direction of the axis, and
wherein part of the plurality of steel sheets contacts the permanent magnet at the end of the magnet insertion hole.

6. (canceled)

7. (canceled)

8. (canceled)

9. (canceled)

10. (canceled)

11. The rotor according to claim 1, wherein the magnet insertion hole extends in a V-shape in a plane perpendicular to the axis.

12. A rotor comprising:
a rotor core having a magnet insertion hole and having an annular shape about an axis; and
two permanent magnets disposed in the magnet insertion hole, the two permanent magnets being disposed on both sides of a center of the magnet insertion hole in a circumferential direction about the axis, each of the two permanent magnets having a flat plate shape and having a thickness and a width in a plane perpendicular to the axis,
wherein the thickness defines a thickness direction, and the width defines a widthwise direction,
wherein the magnet insertion hole has a portion inclined relative to the widthwise direction so that an opening dimension T1 in the thickness direction at an end of the magnet insertion hole in the widthwise direction is smaller than an opening dimension T2 in the thickness direction at the center of the magnet insertion hole in the circumferential direction, and
wherein the magnet insertion hole extends linearly in a plane perpendicular to the axis.

13. A motor comprising:
the rotor according to claim 1; and
a stator surrounding the rotor from outside in a radial direction about the axis.

14. A compressor comprising:
the motor according to claim 13; and
a compression mechanism part driven by the motor.

15. An air conditioner comprising:
the compressor according to claim 14;
a condenser to condense a refrigerant sent out from the compressor;
a decompression device to decompress the refrigerant condensed by the condenser; and
an evaporator to evaporate the refrigerant decompressed by the decompression device.

16. A manufacturing method of a rotor, the method comprising the steps of:
preparing a rotor core having a magnet insertion hole and having an annular shape about an axis; and
inserting a permanent magnet of a flat plate shape in the magnet insertion hole, the permanent magnet having a thickness and a width in a plane perpendicular to the axis,
wherein the thickness of the permanent magnet defines a thickness direction, and the width of the permanent magnet defines a widthwise direction,
wherein the magnet insertion hole has a portion inclined relative to the widthwise direction so that an opening dimension T1 in the thickness direction at an end of the magnet insertion hole in the widthwise direction is smaller than an opening dimension T2 in the thickness direction at a position distanced from the end by the width of the permanent magnet, and
wherein the step of inserting the permanent magnet in the magnet insertion hole comprises the steps of:
inserting the permanent magnet at the position distanced from the end of the magnet insertion hole by the width of the permanent magnet; and
moving the permanent magnet toward the end within the magnet insertion hole.

17. The manufacturing method of a rotor according to claim 16, wherein the magnet insertion hole is formed to allow two permanent magnets to be inserted, and
wherein the two permanent magnets inserted in the magnet insertion hole move toward both ends of the magnet insertion hole in the widthwise direction due to a repulsive force acting between the two permanent magnets.
